(19) United States
(12) Patent Application Publication
(10) Pub. No.: US 2026/0152323 A1
(43) Pub. Date: Jun. 4, 2026

(54) Pallet

(71) Applicant: GRIDESIC HOLDINGS LIMITED, Hong Kong (CN)

(72) Inventors: Thomas Edward Kingsborough Cody, Surbiton (GB); William Thomas Kingsborough Cody, Richmond (GB)

(21) Appl. No.: 19/122,576

(22) PCT Filed: Oct. 20, 2023
(86) PCT No.: PCT/IB2023/060625

§ 371 Date: Apr. 18, 2025

(30) Foreign Application Priority Data
Oct. 21, 2022 (GB) 2215627.7

(51) Int. Cl. B65D 19/00

(52) U.S. Cl. CPC B65D 19/0095; B65D 2519/00024; B65D 2519/00069; B65D 2519/00079; B65D 2519/00273; B65D 2519/00288; B65D 2519/00308; B65D 2519/00323; B65D 2519/00333; B65D 2519/00338; B65D 2519/00363

(57) ABSTRACT

The invention concerns a pallet (100) with a structural top (10), the structural top (10) comprising a loop of tubular material around its perimeter. The invention also concerns a pallet (100) comprising legs (12) and a metal structural top (10), and a coloured detail, provided as a separate component to the metal structured top, the separate component being at least one of a) one of the legs (12), b) a liner (42), and c) a washer, and contrasting to the colour of the structural top (10). The invention also concerns a pallet (100) comprising legs (12) and a structural top (10), wherein the legs (12) are attached to the structural top (10) using nuts and bolts. The pallet (100) can comprise one or more of a) a liner (12), b) a washer, and c) either a structural bottom or one or more structural skid (14), the nuts and bolts connecting that or those component(s) to the structural top (10) and leg (12).

The present invention relates to a pallet, and a method of manufacturing the pallet.

Pallets are commonly made of a plastics material, a plastic composite or wood.

Wooden pallets tend to be formed from multiple elements, including slats for forming the top and the skids, or both the top and the bottom, which slats may be joined together within the respective top or bottom via further slats extending perpendicular thereto, plus also blocks for spacing the top from the bottom, or the top from the skids. These various elements are usually joined together using nails, although screws or staples, and sometimes glue or adhesive can also or instead be used. Such wooden pallets can often be repaired through replacement of one or more of the wooden elements, for example if they are cracked or broken in use. This can occur when the pallets have been returned to the distributor or pooling company. Other wooden pallets, however, are single use pallets. Single use pallets are commonly produced using a low-grade timber. For repairable pallets, however, a higher grade of wood is commonly used—for example a hardwood, or a better grade of softwood, or a thicker piece of wood. The elements that typically break are the slats—particularly the skids or the top and/or bottom of the pallet.

Plastic pallets, on the other hand, are much more frequently provided as a multiple-use pallet, and part of a pooling stock, and thus are leased by produce distributors, or product manufacturers, from a pooling company. The pooling company collects pooling stock pallets back from their customers and redistributes them within their distribution pool. Due to the commonly more flexible (or durable) nature of plastic pallets versus wooden pallets, a plastic pallet is less frequently badly damaged during use. Damage is more commonly a scratch rather than a breakage, whereby they are typically not needing any repairs. As plastic pallets are commonly formed as a single piece (for example a single moulded component), repairs are more difficult in any event, so repairs may not be economically viable. Instead, therefore, such plastic pallets might instead be recycled (i.e. pelletized and melted down for recasting). However, due to the nature of the plastics used (frequently a fibre reinforced plastic), they are not necessarily recast as a pallet.

A third material choice that is available for pallets is metal. This is most typically aluminium or steel, although a steel pallet is often going to be very heavy due to the higher density of steel required for strength compared to aluminium, plastic and wood. Metal pallets are thus not currently in wide use. Nevertheless, bespoke pallets made of metal are known to exist in various industries.

A particularly beneficial form of structural element for use as the top and bottom, or the top and skids, of such metal pallets has been developed by the present applicants, and is disclosed in their earlier patent application, WO 2015/185925, the entire contents of which are incorporated herein by way of reference. Although its design is not specific to metal pallets, in that the material for the structural element in that patent can be metal, plastic or fibrous materials such as paper or cardboard, metals such as steel and aluminium are particularly beneficial as the material of choice for the structural elements in a pallet, especially where the pallet is intended for use in a pallet pool, and thus being one for multiple reuse, and/or for a wide ranging area of distribution—either nationally, internationally or globally, as such structural elements will be particularly tough and resilient—resistant to damage or breakage. Indeed, many other metals could also be suitable, such as titanium, tin, zinc, brass, pewter, copper or bronze, or many of the various alloys thereof, or many of the various alloys of steel and aluminium, including but not limited to stainless steels or galvanised or electroplated metals.

In WO 2015/18592, the structural element uses two sheets of material, each provided with an array of opposing pods, which pods are joined together at their respective bases to form a rigid structure. By positioning the pods close together, the rigidity is increased as the structure can then approximate a space frame-like effect in that forces from bending stresses can distribute across the surfaces of the pods, and through the apexes between adjacent pods, and through the joined floors of the pods, thus distributing loads throughout the structure. This leads to the main benefit of the structural element in WO 2015/185925 for making it suitable for use in forming a top or bottom of, or the rails of, a pallet: the unexpectedly high structural rigidity of the structural element, which rigidity is multi-directional, and this is achieved despite that structural element being formed from only two plies of sheet material. This contrasts to a conventional corrugated sheet-which requires three plies of material, a central one of which has transversely extending corrugations. By having three plies, it is 50% heavier than the above two-ply structural element, and due to the transversely extending corrugations, it only has one main axis of rigidity (across the corrugations); and its rigidity in a perpendicular axis will be significantly lower.

However, one area of weakness that can arise with the structural element of WO 2015/185925, especially when used in a pallet, is its edge strength. As a pallet is frequently loaded and unloaded from a vehicle using a forklift truck, the edges of the structural element can be impacted by the forks of the forklift truck. Those edges can thus become damaged, which can then expose the internal structure of the structural element to the points of those forks, which can eventually weaken the joints between the bases of the pods, and thus weaken the integrity of the structural element. Furthermore, tears or dents in the edges of the structural element can lead to sharp edges, especially when the material is a metal, which can increase the risk of injury to consumers or personnel.

Another area of weakness in the pallets disclosed in WO2015/185925 is the use of deeper draws in the sheet metal used to form the structural element for forming legs of the pallet. This achieves a one-piece structure, which simplifies manufacture, but leads to similar issues with servicing as found with the plastic pallets discussed above. The deeper draw can also lead to weaknesses in the material. Forming a separate skid is also disclosed in WO2015/185925, but that skid is still having to be attached to the pallet-by welding, which again leads to a “one piece” structure, and thus difficulties with servicing, with the associated higher costs thereof.

With the present invention, it would also be desirable to enable identification of an owner of a pallet from a distance. Conventional wooden pallets are typically painted or stained for this purpose, and conventional plastic pallets can be made of a coloured plastic. These approaches all enable identification so that a pooling company can know which pallets are theirs when collecting them up, or when redistributing/servicing them. However, metals can be difficult or costly to stain, and painting metal pallets is less desirable than for wooden and plastic pallets, as the paint readily scratches off the metal, quickly leading to an inferior appearance for the pallet, and a high cost if the pallet ever needs respraying as a consequence of this—since all the paint may need to be removed first in order for the respray to give a long lasting and high quality finish.

Painting or staining metal can also detract from the pleasing appearance of a metal pallet—particularly a stainless steel, galvanised or nickel/chrome plated pallet.

The present invention seeks to provide a novel design of pallet that solves at least some of these issues.

According to a first aspect of the present invention there is provided a pallet with a structural top, the structural top comprising a loop of tubular material around its perimeter.

The provision of the loop of tubular material allows a strong “bumper” to be provided around the edge of the pallet. This bumper can help to avoid damage of the edge of the pallet during interaction of a forklift truck with the pallet, as the bumper (a tube of material) will be harder to tear than a folded edge or a welded edge.

In some embodiments the external height of the loop of tubular material is at least 50% of the height of the structural top of the pallet (measured perpendicular to the upper plane of the pallet), and more preferably at least 80% thereof. In some embodiments it is at least 90%, at least 95% or even at least 98% of the height of the structural top of the pallet. It may even have the same height as the structural top—for example defining the height of the structural top, with the rest of the structural top—inside the loop—having a lesser height.

In some embodiments the tubular material has a generally round section, but more typically, it has a varying shape around its circumference. For example the tubular material may have a tubular section that is not a perfectly round section—for example it can have flattened sides—these may be either side of arcuate areas defining a common radius.

In some embodiments the largest diameter of the tubular section is at least 20 mm, and preferably it is between 20 and 35 mm. In some embodiments the smallest diameter of the tubular section is 15 mm, and preferably it is between 15 mm and 32 mm.

In some embodiments the loop of tubular material has a wall thickness around its tubular section of at least 1.5 mm, and preferably a thickness of between 1.5 mm and 4 mm.

In some embodiments the structural top has a maximum thickness not exceeding 35 mm.

In some embodiments, the loop of tubular material is a single length of tubular material, bent or formed around a structure of the structural top to form the perimeter of the structural top.

In some embodiments the loop of tubular material is formed into its loop and a structure is formed inside the loop to provide a central structure of the structural top.

In some embodiments the structural top comprises the loop of tubular material, a top sheet and a bottom sheet, perimeters of the top sheet and the bottom sheet being welded or bonded to the loop of tubular material. With this structure, it is preferred that the wall thickness of the loop of tubular material around its tubular section is greater than the wall thickness of the top sheet (and preferably of the bottom sheet as well). The top sheet and the bottom sheet would usually both be formed from sheets of a common thickness. That common thickness is usually less than 1.5 mm.

In some embodiments the structural top is formed only from the top sheet, the bottom sheet and the loop of tubular material.

In some embodiments, the two sheets that form the top sheet and the bottom sheet are each deformed at intervals along their respective lengths and widths to provide pods that protrude inward, relative to outer extremities of the structural top, from a respective outer plane of the respective sheet.

With this structure, the two sheets are the outermost sheets of the structural panel.

In some embodiments the two sheets are juxtaposed to each other in mirror-image, or facing, fashion, with their respective pods being inwardly oriented, such that floors of opposing pods engage in contact zones, the opposing pods being joined together at those contact zones.

In some embodiments the opposing pods are joined together by welding them together at their floors—i.e. in the contact zones.

In some embodiments the pods have openings in their floors. For example, every pod may have a hole in its floor.

In some embodiments, the walls of the pods in both sheets slope obliquely relatively to the respective outer plane of the respective sheet, with substantially straight sides in section, to define frusto-conical cone-like shapes, or frustrated pyramid-like shapes.

The cone or pyramid-like shapes can have rounded regions (in section) between the floors thereof and the substantially straight sides, and at or between apexes thereof between adjacent pods and the substantially straight sides.

In some embodiments the apexes between adjacent pods in each sheet are substantially rounded in section with little or no flat surface remaining between adjacent pods in each sheet at their closest points. In the case of square pods, or triangular or hexagonal pods, or in other pod configurations that can occupy the entire extent of the top and bottom sheets, there may be no flat surface remaining between adjacent pods in each sheet if the apexes between adjacent pods are fully rounded.

It is preferred that the pods are round, hexagonal or square.

The pods may be arranged in an array, and/or they may be arranged in staggered rows—for example to allow them to intermesh for occupying a greater extent of the outer surfaces of the top and bottom sheets, or to enable a greater density of pods in the area of the top and bottom sheets.

In preferred configurations the pods act across the structural top as interconnecting diagonal braces whereby loads on the structure will be transmitted along the surfaces of the pods in multiple directions and distributed throughout the structural panel formed thereby. This is best achieved by the pods in each sheet having a close proximity to one another (preferably with no more than a 2 mm flat region at the outer apex at the closest point between adjacent pods in each sheet) in order to be mechanically interdependent.

In some embodiments the walls of neighbouring and opposed pods together form diamond beam formations (i.e. rhomboid sectioned, or potentially single or perpendicular axis symmetrical, quadrilateral sectioned) between adjacent pairs of engaged pods such that multiple diamond beam structures are formed by the diamond beam formations in the structural panel in negative spaces immediately between pairs of engaged pods. Minimal rounding at the apexes or corners of these diamond beams is permissible—i.e. typically no more than 5 mm radiuses, or more preferably 3, 2 or 1 mm radiuses.

In some embodiments the top and bottom sheets act as tensile and compression chords for the structural panel, the inwardly orientated pods having pod apexes that are joined together, which pods have a close proximity to one another in order to be mechanically interdependent, creating a double depth space-frame lattice type matrix where loads placed on a surface of the structural panel are resisted and transferred through the chords.

In preferred embodiments, walls of the diamond beam formations are straight between outwardly oriented, rounded, apexes of the diamond beam formations and the floors of the inwardly oriented pods, to define a generally constant slope for those walls.

In some embodiments the loop of tubular material is formed from a bent tube of metal. For example the material may be steel, aluminium, titanium, tin, zinc, brass, pewter, copper or bronze, or an alloy thereof. In some embodiments the material may be a stainless steel or a galvanised or electroplated metal.

In some embodiments the tubular material has a substantially constant section around the majority of the loop, although the section may vary slightly where the loop is bent around a corner. For example, the structural top may be generally rectangular, albeit with rounded corners, the tubular material having a substantially constant section along the sides, but a deflected section where it bends around the corners.

In some embodiments the tubular material has an external profile on a top portion and a bottom portion of the loop that provides a flatter region for receiving a top sheet and a bottom sheet of the structural top-e.g. the top and bottom sheets discussed above. This flatter region can be flatter than the rest of the external profile around the section of the tubular material, the rest of the profile being generally arcuate. The tubular section thus may approximate a circle with flattened or slightly flattened side regions. Those flattened or slightly flattened side regions may taper relative to one another towards the inside of the loop. Preferably the angle of each taper may be between 2 and 10 degrees relative to the upper or lower surface of the structural top. More preferably the angle of the taper is between 3.5 and 6 degrees. In place of (or additional to) the tapers, a recess may be provided to accommodate the thickness of the top and bottom sheets.

In some embodiments the loop contacts the straight part of the walls of outermost pods around the structural top.

The section of the tubular material around the loop is preferred to be symmetrical about a transverse plane of the loop. It thus may touch straight walls of pods in both the top sheet and the bottom sheet.

In some embodiments the pallet comprises one or more legs. Typically the pallet comprises at least four legs.

In some embodiments the pallet comprises a structural bottom or one or more structural skids. Legs may extend between the structural top and the structural bottom, or between the structural top and the one or more structural skid.

In some embodiments, the structural bottom or the structural skid comprises a loop of tubular material around its perimeter. The structural bottom or the structural skid may comprise a similar or common structure to the structural top, albeit in the case of a structural skid with a narrower loop and overall width dimension (measured parallel to the top). For example, the bottom or skid may also feature a pod-based structural panel design.

In the case of a structural bottom, the structural bottom may mirror the structural top.

In the case of a structural skid, the pallet may comprise two or more structural skids—for example two outer skids that mirror each other. In some embodiments there is a third, or a central, skid. The third or central skid may comprise a similar structure to the structural top, albeit with a narrower loop due to its overall width dimension (i.e. measured parallel to the top) being smaller.

As above, the pallet may comprise legs, and the legs may be formed in the structural top or in the structural bottom, or in the structural skid(s). These legs can join between the structural top and the structural bottom (or skid(s)). However, in a preferred configuration, the legs are separately formed blocks fitted between the respective top and bottom components.

In some embodiments the top and bottom (or skids) are joined via the legs with welding. However, in a preferred configuration the top and bottom, or the top and the skids, are joined via the legs using nuts and bolts—for example through holes in the structural top, the structural bottom (or skids) and the legs.

Washers may be used to spread the loading from the nuts and heads of the bolts.

In some embodiments the legs are made of a plastics or composite material and the structural top and the structural bottom (or the structural skids) are made of metal.

In some embodiments the legs are moulded or extruded and moulded post-extrusion.

In some embodiments the legs are 3D printed.

In some embodiments, liners are provided between the legs and the structural top, and or the structural bottom (or the structural skids).

In some embodiments the liners are made of a plastics or composite material.

In some embodiments the legs and/or the liners and/or the washers are painted or made of a coloured material. This may be to contrast with the colour of the structural top, and/or the structural bottom/skids. This painting or colour of the legs and/or the liners and/or the washers can enable pooling companies to use a colour to identify their products without needing the structural top and/or the structural bottom or skids to be similarly coloured, whereby the structural top and/or the structural bottom or skids can be left with their metallic finish. This allows the wear and tear of the pallets to be less visually unappealing as little or no paint is needed on the top (or bottom) surface of the pallet, which surfaces are those that are most visual to customers when handling the pallets.

The present invention thus also provides, in accordance with a second aspect of the present invention, a pallet comprising legs and a metal structural top, and a coloured detail, provided as a separate component to the metal structured top, the separate component being at least one of a) one of the legs, b) a liner, and c) a washer, and contrasting to the colour of the structural top.

As above, by providing this coloured component it will contrast with the colour of the structural top to enable pooling companies to identify their products without needing the structural top to be similarly coloured.

In some embodiments the legs are attached to the structural top using nuts and bolts.

In some embodiments the coloured detail is provided by painting the separate component, but more preferably it is provided by making the separate component from a coloured plastic or composite material. It is then less susceptible to having its colour scratched off. However, by being in a less visually impactful position on the pallet compared to the uppermost surface of the pallet (or by being only a small part of the upper surface, and recessed back from the uppermost surface—e.g. in the case of a washer above the structural top, but in one of its pods, or a recessed hole, between a bolt head or nut of a nut and bolt used to attach the leg to the structural top), it is also either less likely to be scratched or less likely to be so significantly visually depreciated than a scratched paint line on the structural top, so painting that separate component is also an option.

In some embodiments the liner is a component that is assembled between one of the legs and either the structural top or a structural bottom or a structural skid of the pallet (if so provided) such that at least a part of a perimeter thereof remains visible after assembly of the pallet. In some embodiments only at least that part of a perimeter might be provided in the contrasting colour.

In some embodiments the structural top is as defined above with reference to the first aspect of the present invention. However, for this second aspect, the structural top might not comprise the loop of tubular material. Therefore, in some embodiments the structural top is a structural element as defined in WO 2015/185925.

In some embodiments the structural top comprises a top sheet and a bottom sheet, the two sheets that form the top sheet and the bottom sheet being each deformed at intervals along their respective lengths and widths to provide pods that protrude inward, relative to outer extremities of the structural top, from a respective outer plane of the respective sheet.

In some embodiments the two sheets are juxtaposed to each other in mirror-image, or facing, fashion, with their respective pods being inwardly oriented, such that floors of opposing pods engage in contact zones, the opposing pods being joined together at those contact zones.

In some embodiments the opposing pods are joined together by welding them together at their floors—i.e. in the contact zones.

In some embodiments the pods have openings in their floors. For example, every pod may have a hole in its floor. In a preferred configuration, the bolts for attaching the legs to the structural top extend through some of these holes (or all of them if the holes are only provided in the pods aligning with the legs).

In some embodiments, the walls of the pods in both sheets slope obliquely relatively to the respective outer plane of the respective sheet, with substantially straight sides in section, to define frusto-conical cone-like shapes, or frustrated pyramid-like shapes.

The cone or pyramid-like shapes can have rounded regions (in section) between the floors thereof and the substantially straight sides, and at or between apexes thereof between adjacent pods and the substantially straight sides.

In some embodiments the apexes between adjacent pods in each sheet are substantially rounded in section with little or no flat surface remaining between adjacent pods in each sheet at their closest points. In the case of square pods, or triangular or hexagonal pods, or in other pod configurations that can occupy the entire extent of the top and bottom sheets, there may be no flat surface remaining between adjacent pods in each sheet if the apexes between adjacent pods are fully rounded.

It is preferred that the pods are round, hexagonal or square.

The pods may be arranged in an array, and/or they may be arranged in staggered rows—for example to allow them to intermesh for occupying a greater extent of the outer surfaces of the top and bottom sheets, or to enable a greater density of pods in the area of the top and bottom sheets.

In preferred configurations the pods act across the structural top as interconnecting diagonal braces whereby loads on the structure will be transmitted along the surfaces of the pods in multiple directions and distributed throughout the structural panel formed thereby. This is best achieved by the pods in each sheet having a close proximity to one another (preferably with no more than a 2 mm flat region at the outer apex at the closest point between adjacent pods in each sheet) in order to be mechanically interdependent.

In some embodiments the walls of neighbouring and opposed pods together form diamond beam formations (i.e. rhomboid sectioned, or potentially single or perpendicular axis symmetrical, quadrilateral sectioned) between adjacent pairs of engaged pods such that multiple diamond beam structures are formed by the diamond beam formations in the structural panel in negative spaces immediately between pairs of engaged pods. Minimal rounding at the apexes or corners of these diamond beams is permissible—i.e. typically no more than 5 mm radiuses, or more preferably no more than 3, 2 or 1 mm radiuses.

In some embodiments the top and bottom sheets act as tensile and compression chords for the structural panel, the inwardly orientated pods having pod apexes that are joined together, which pods have a close proximity to one another in order to be mechanically interdependent, creating a double depth space-frame lattice type matrix where loads placed on a surface of the structural panel are resisted and transferred through the chords.

In preferred embodiments, walls of the diamond beam formations are straight between outwardly oriented, rounded, apexes of the diamond beam formations and the floors of the inwardly oriented pods, to define a generally constant slope for those walls.

In some embodiments the legs and/or the liners and or the washers are formed with a profiled top or bottom that fits into one or more of the pods so that the pods and the legs, liners and/or washers self-align within the pods to facilitate assembly of the pallet. By self-aligning, the insertion of the bolts through the holes through the structural top and the leg, and where provided, the liner and/or the washers, is facilitated—it is made much easier. This also allows simpler servicing of the pallets should the structural top, or a leg, or a washer or liner if provided, or a structural bottom or structural skid, when provided, be damaged to a point at which it needs to be replaced or repaired.

Given this advantage, the present invention also provides, in accordance with a third aspect of the present invention, a pallet comprising legs and a structural top, wherein the legs are attached to the structural top using nuts and bolts.

In some embodiments the pallet also comprises one or more of a) a liner, b) a washer, and c) either a structural bottom or one or more structural skid, the nuts and bolts also connecting that or those component(s) to the structural top and leg.

In some embodiments, the liner is provided as a component that is assembled between one of the legs and either the structural top or a structural bottom or a structural skid of the pallet (if so provided). In some embodiments the liner is sized such that at least a part of a perimeter thereof remains visible after assembly of the pallet.

In some embodiments the legs and/or the liners and or the washers are formed with a profiled top or bottom that fits into one or more of the pods so that the pods and the legs, liners and/or washers self-align within the pods to facilitate assembly of the pallet. By self-aligning, the insertion of the bolts through the holes through the structural top and the leg, and where provided, the liner and/or the washers, is facilitated—it is made much easier. This also allows simpler servicing of the pallets should the structural top, or a leg, or a washer or liner if provided, or a structural bottom or structural skid, when provided, be damaged to a point at which it needs to be replaced or repaired.

In some embodiments, the legs or the liners have a top or bottom profile, or both, that fits into at least two of the pods in the structural top, or into pods in the structural bottom or skids, if provided. By fitting into two or more of the pods, the self-alignment can also include guiding the orientation of the components relative to one another.

In a preferred embodiment the legs or liners have profiles to fit in at least four pods, and more preferably five or six pods.

In a preferred embodiment at least four bolts affix each leg to the structural top. Each bolt may extend through one of the pods in which the liners or legs fit.

The leg may be provided with a guide-hole through it for each bolt. The leg may have a substantially hollow structure, with internal scaffolds for rigidity.

The pallet of the third aspect may additionally be in accordance with the first or second aspect of the present invention. For example, as with the second aspect, in some embodiments the structural top is as defined above with reference to the first aspect of the present invention. However, as for the second aspect, the structural top might not comprise the loop of tubular material. Therefore, in some embodiments the structural top is a structural element as defined in WO 2015/185925.

In some embodiments the structural top comprises a top sheet and a bottom sheet, the two sheets that form the top sheet and the bottom sheet being each deformed at intervals along their respective lengths and widths to provide pods that protrude inward, relative to outer extremities of the structural top, from a respective outer plane of the respective sheet.

In some embodiments the two sheets are juxtaposed to each other in mirror-image, or facing, fashion, with their respective pods being inwardly oriented, such that floors of opposing pods engage in contact zones, the opposing pods being joined together at those contact zones.

In some embodiments the opposing pods are joined together by welding them together at their floors—i.e. in the contact zones.

In some embodiments the pods have openings in their floors. For example, every pod may have a hole in its floor. In a preferred configuration, the bolts for attaching the legs to the structural top extend through some of these holes (or all of them if the holes are only provided in the pods aligning with the legs).

In some embodiments, the walls of the pods in both sheets slope obliquely relatively to the respective outer plane of the respective sheet, with substantially straight sides in section, to define frusto-conical cone-like shapes, or frustrated pyramid-like shapes.

The cone or pyramid-like shapes can have rounded regions (in section) between the floors thereof and the substantially straight sides, and at or between apexes thereof between adjacent pods and the substantially straight sides.

In some embodiments the apexes between adjacent pods in each sheet are substantially rounded in section with little or no flat surface remaining between adjacent pods in each sheet at their closest points. In the case of square pods, or triangular or hexagonal pods, or in other pod configurations that can occupy the entire extent of the top and bottom sheets, there may be no flat surface remaining between adjacent pods in each sheet if the apexes between adjacent pods are fully rounded.

It is preferred that the pods are round, hexagonal or square.

The pods may be arranged in an array, and/or they may be arranged in staggered rows—for example to allow them to intermesh for occupying a greater extent of the outer surfaces of the top and bottom sheets, or to enable a greater density of pods in the area of the top and bottom sheets.

In preferred configurations the pods act across the structural top as interconnecting diagonal braces whereby loads on the structure will be transmitted along the surfaces of the pods in multiple directions and distributed throughout the structural panel formed thereby. This is best achieved by the pods in each sheet having a close proximity to one another (preferably with no more than a 2 mm flat region at the outer apex at the closest point between adjacent pods in each sheet) in order to be mechanically interdependent.

In some embodiments the walls of neighbouring and opposed pods together form diamond beam formations (i.e. rhomboid sectioned, or potentially single or perpendicular axis symmetrical, quadrilateral sectioned) between adjacent pairs of engaged pods such that multiple diamond beam structures are formed by the diamond beam formations in the structural panel in negative spaces immediately between pairs of engaged pods. Minimal rounding at the apexes or corners of these diamond beams are permissible—i.e. typically no more than 5 mm radiuses, or more preferably no more than 3, 2 or 1 mm radiuses.

In some embodiments the top and bottom sheets act as tensile and compression chords for the structural panel, the inwardly orientated pods having pod apexes that are joined together, which pods have a close proximity to one another in order to be mechanically interdependent, creating a double depth space-frame lattice type matrix where loads placed on a surface of the structural panel are resisted and transferred through the chords.

In preferred embodiments, walls of the diamond beam formations are straight between outwardly oriented, rounded, apexes of the diamond beam formations and the floors of the inwardly oriented pods, to define a generally constant slope for those walls.

In both the second and third aspects, the structural bottom or the structural skids, when provided, may have a similar structure as the structural top.

In the third aspect, as with the preceding aspects, the leg and/or the liner may be made of a plastics or composite material. When provided, the washer will usually be a metal component, although it may be a plastics or composite material. In some embodiments it is a two-part component-with a plastic coloured part and a metal load-spreading part.

The present invention will now be described in further detail, purely by way of example, with reference to the accompanying drawings, in which:

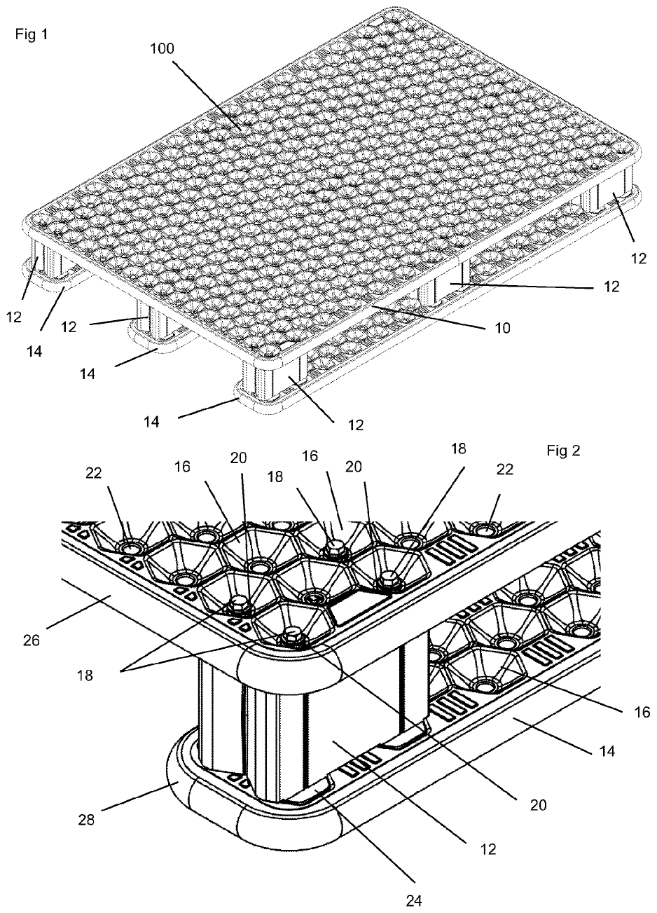

FIG. 1 shows a pallet in accordance with the present invention, with a structural top, nine legs and three structural skids;

FIG. 2 shows a more detailed view of the front right corner of the pallet of FIG. 1, showing the fit of the leg into the skid;

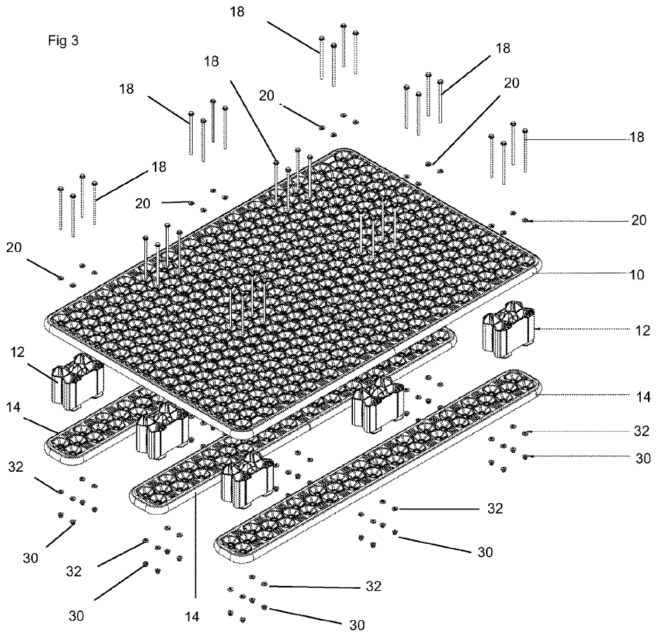

FIG. 3 shows an exploded view of the pallet of FIG. 1, detailing structural top, the nuts, bolts, washers, legs and skids of the pallet;

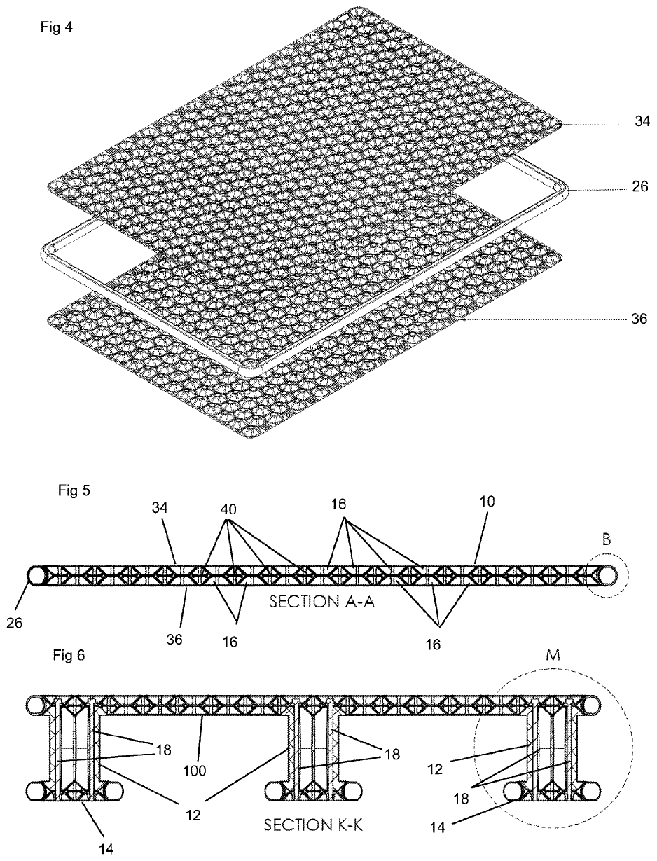

FIG. 4 shows an exploded view of the structural top of the pallet of FIG. 1; a structural bottom could potentially be identical;

FIG. 5 shows a section through the structural top of the pallet of FIG. 1;

FIG. 6 shows a section through the structural top, three of the legs and the three skids of the pallet of FIG. 1;

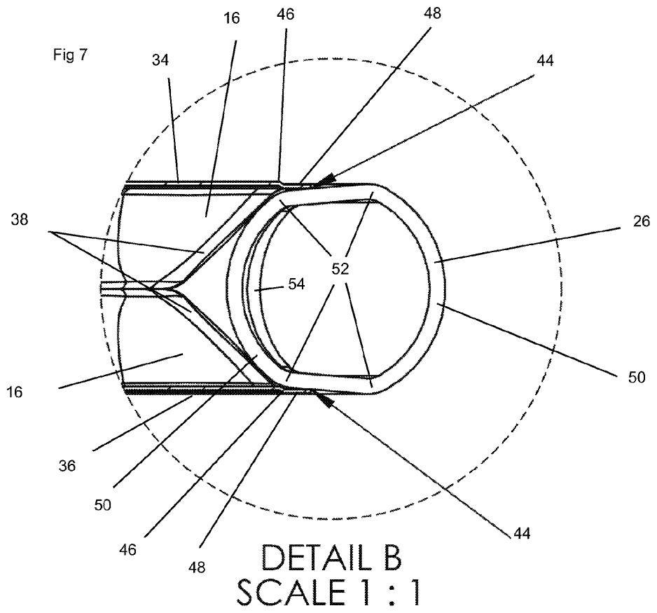

FIG. 7 shows an enlarged view of detail B of FIG. 5;

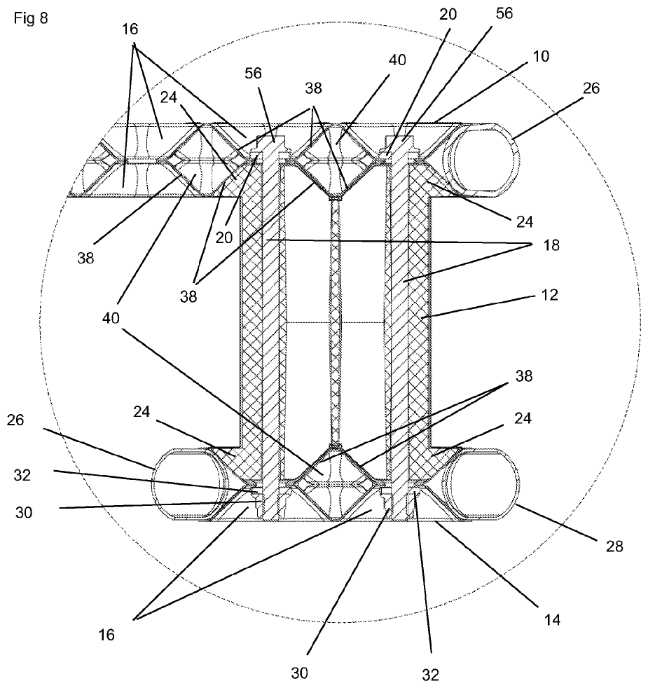

FIG. 8 shows an enlarged view of detail M of FIG. 6;

FIG. 9 shows an exploded view of a second pallet in accordance with the present invention, with a structural top, nuts, bolts and washers, two liners for each leg, nine legs and three skids;

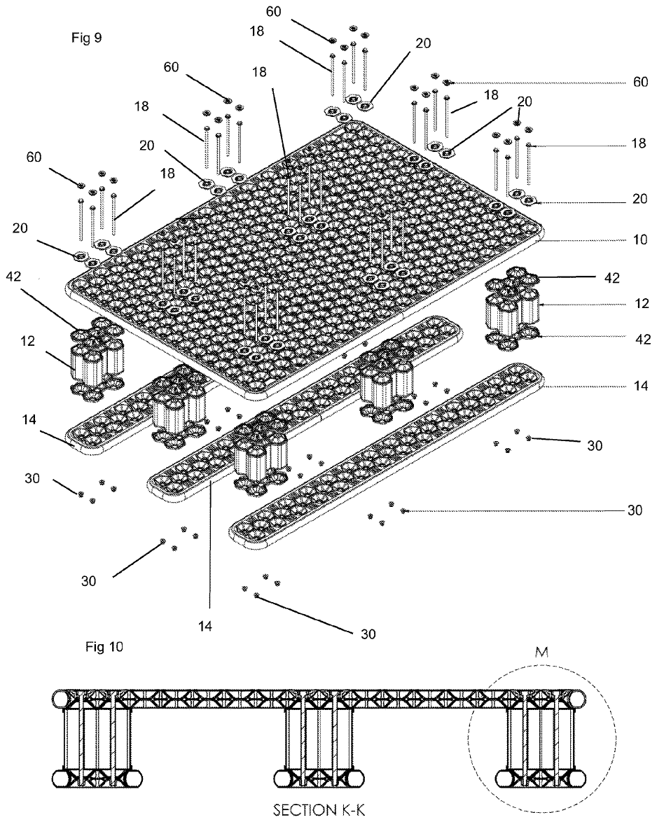

FIG. 10 shows a section through the structural top, three of the legs and the three skids of the second pallet in assembled form;

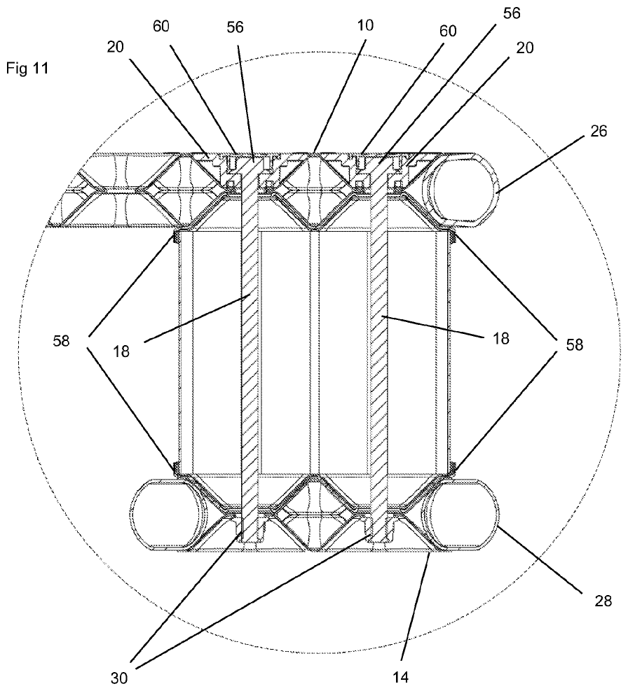

FIG. 11 shows an enlarged view of detail M in FIG. 10;

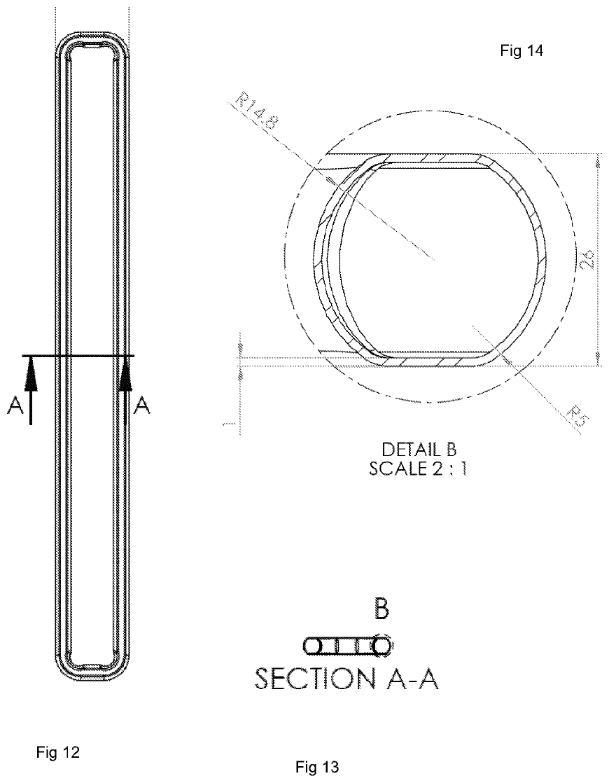

FIG. 12 shows a loop of tubular material in plan view, suitable for forming one of the skids of the first or second pallet;

FIG. 13 shows a section A-A through the loop of FIG. 12;

FIG. 14 shows an enlarged view of detail B from FIG. 13;

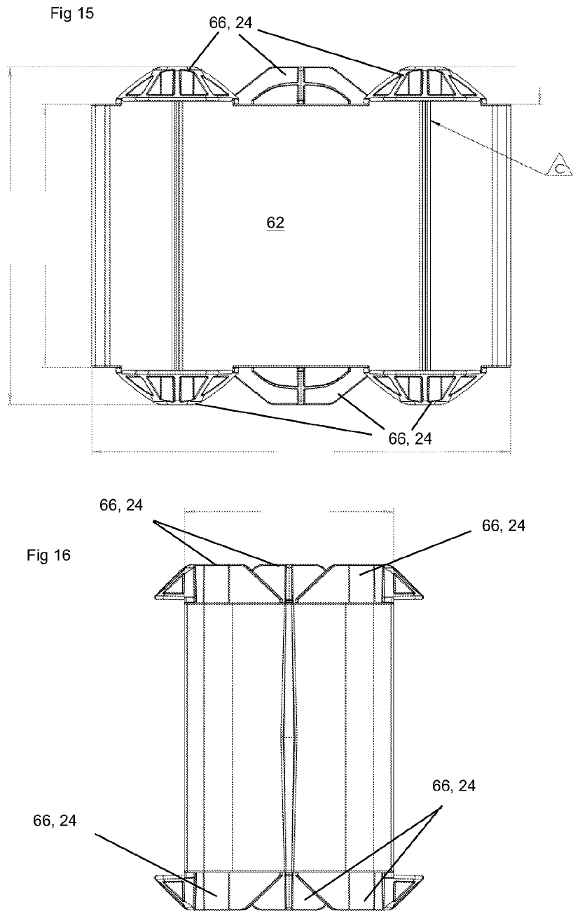

FIG. 15 shows a side elevation of a leg from FIG. 3;

FIG. 16 shows an end elevation of the leg of FIG. 15;

FIG. 17 shows a top plan view of the leg of FIG. 15; and

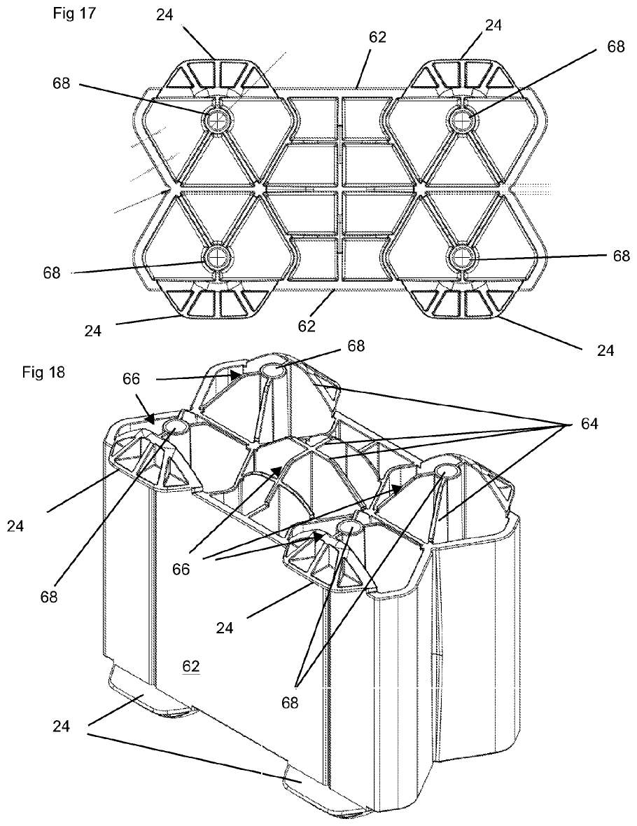

FIG. 18 shows a perspective view of the leg of FIG. 15, illustrating the profiled top form of the leg for fitting into pods of the structural top, the leg also having a corresponding profile provided at the bottom for fitting into pods of the structural skid.

Referring first of all to FIG. 1 there is shown a pallet 100 of a first embodiment of the present invention. This pallet 100 has a structural top 10, nine legs 12, of which five are visible and four are hidden by the structural top 10, and three skids 14. Each skid 14 is attached to the structural top 10 via three of the legs 12. This pallet 100 is known as a full-size pallet. Other sizes of pallet are also known. For example there is a half pallet, which may have two or three skids and six legs, in which the skids may extend either along the long or the short sides of the pallet, this half pallet being approximately the size of the above pallet cut in half along its long length. There is also a quarter pallet which is cut in half again to be of a size approximately ¼ of the size of the full pallet. ¼ pallet is likely to have just two skids extending along the long sides of the structural top, and likely just four legs.

Instead of skids 14, a structural bottom may be provided, corresponding to the structural top 10. In such an arrangement, the legs all connect the structural bottom and the structural top together.

Referring next to FIG. 2, more details of the closest corner of the pallet of FIG. 1 is shown. As can be seen, the structural top 10 has a series of hexagonal pods 16 formed in its top surface and a tubular edge 26 surrounds the structural top 10, as will be described in greater detail below. Similarly, a tubular edge 28 surrounds the skid 14, as will also be described in further detail below.

In FIG. 2, bolts 18 can be seen extending through the bases of those pods 16, with washers 20 between the heads 56 of those bolts 18 and the bases of those pods 16. Those bolts extend all the way through the legs 12 and the skids 14, as will be described in further detail with reference to FIGS. 3 and 8.

Like the structural top 10, the skids 14 have a series of pods 16 formed in its top surface. These are again hexagonal. Although hexagonal pods are shown, as described in WO 2015/185925 the pods can be of different shapes, such as square, round, triangular or other polygonal shapes. Indeed, irregular shapes are also possible but are less preferred due to the less predictable structural strength of such structural elements.

As can be seen in FIG. 2, the leg 12 has a profiled bottom with feet 24 that fit in at least four of the pods in the skid 14. As shown later in the application, this particular embodiment has legs 12 with a profiled top and bottom for fitting each into five of the pods 16 in the structural top 10 and the skids 14.

Referring next to FIG. 3, an exploded view of the pallet 100 is shown. As can be seen, each of the legs has a profiled top for fitting into pods in the underside of the structural top 10, with a matching profiled bottom being provided for fitting into the pods 16 of the skids 14. The bolts 18 can then be inserted through holes in the bases of the respective pods 16 in the top surface of the structural top 10, through the legs 12 and through the skids 14 before being tightened at their free ends at the bottom of the pallet 100 again using nuts 30. The washers 20 fit between the head of the bolts 18 in the uppermost pods and corresponding washers 32 fit between the nuts 30 and the lowermost pods in the bottom of the skids 14. The pallet can thus simply be bolted together using the nuts, bolts and washers after assembling the structural top 10 over the legs 12 on the skids 14.

Referring next to FIG. 4, a preferred mode of assembling the structural top, or a structural bottom, and likewise a structural skid, is shown. As can be seen, the structural top comprises the loop 26 of tubular material, usually steel or aluminium, and top and bottom sheets 34, 36. Each of these top and bottom sheets is provided with an array of pods 16 inwardly depressed therein, which pods 16 form opposing pairs of corresponding pods 16 between the top and bottom sheets 34, 36. Where the opposing pods touch, they are joined together, for example with welding. Part of the bottoms of the pods may be punched out to leave holes 22, as shown in FIG. 2.

Referring next to FIG. 5, a section through the assembled structural top 10 is shown. This shows the adjacent pairs of opposing pods 16 forming diamond beam formations 40 there between, as shown in greater detail in FIG. 8. These diamond beam formations 40 take the approximate form of a rhombus, having substantially straight sides 38 from the straight walls 38 of the pods 16 either side thereof. A more detailed view of area B from FIG. 5 is shown in FIG. 7.

Referring to FIG. 7, a section through the loop 26 of tubular material is shown in greater detail. As can be seen, the tubular material has a generally circular cross-section, albeit with two flattened sides 44. These flattened sides 44 taper towards one another towards the inside of the loop 26. In the illustrated example, the taper angle is 4.8° from the upper (or lower) surface of the structural top. However, a range of angles from greater than 0° to 10° could equally be accommodated. In an alternative configuration, in place of the taper, the flattened sides 44 may be parallel to one another, as shown in FIG. 14—for the loop 28 of the skid 14.

It Is Also Possible for These Flattened Sides to Take the Form of a Step or Recess.

The flattened sides are provided to simplify the connection of top and bottom sheets 34, 36 of the structural top to the loop 26. By being flat, a greater surface area of the top and bottom sheets 34, 36 will be in contact with the loop 26, whereby connecting there between can more readily provide a firm connection. Typically this connection will be by way of a weld.

As shown in FIG. 7, the top and bottom sheets 34, 36 may have a tapering edge for matching the angle of the flattened sides 44 to further improve the connection. For this purpose, the top and bottom sheets 34, 36 may be deflected inwardly to form a step 46, whereby the tapering edge might be replaced instead with an angled edge.

As shown in FIG. 7, in this embodiment the loop 26 contacts the sides or straight walls 38 of the pods 16 immediately adjacent thereto. This reduces the length of the arms 48 from the pods 16.

Either side of the flattened sides 44, arcuate portions of the tubular material complete the perimeter of the tubular material, with tighter radius regions connecting the arcuate portions to the flattened sides 44. By having a complete perimeter, the tubular material has added strength versus a C-shaped capping to the sides of the structural top 10. Likewise, by being generally circular, the tubular material has added strength. However, it might instead be oval or some other sectional shape with a complete perimeter.

Inside the tubular material, FIG. 7 also shows a displaced region which occurs at the corners of the loop due to deflection of the tubular section as the tubular material is bent around the corners of the pallet 10.

Referring next to FIG. 6, a further section through the pallet 100 is shown, parallel to that of FIG. 5, but now instead incidental with three of the legs 12, and in particular two of the bolts extending through the pallet. This section thus shows the way in which the bolts 18 connect between the structural top 10 and the skids 14, with the legs 12 there between. This is configuration for the bolts is shown in more detail in FIG. 8.

Referring to FIG. 8, a section through two of the bolts 18 and a leg 12 is shown. Each has a head 56 sitting at the top of the bolt 18 in one of the pods 16 in the top sheet 34 of the structural top 10. Below the head 56 of the bolts 18, a washer 20 is provided. In this embodiment, this washer 20 is a metal washer 20. It sits against a flange around a hole 22 in the pod 16, and thus engages against the top sheet 34. The head 56 sits on the washer 20. The bolt 18 then extends through the structural top 10 into the opposing pod 16 in the bottom sheet, which first and second pods 16 form a pair of pods 16. Within that opposing pod 16 one of the feet 24 of the legs 12 is positioned. The bolts 18 extend also into the foot 24 of the leg 12 and extend through the leg to the foot 24 at the bottom of the leg 12. The bolts 18 then extend through a hole 22 in the parent pods 16 in the skid 14 whereat a further washer 32 and a nut 30 are used to tighten the assembly together. In this embodiment, the section of FIG. 8 cuts through to such bolts 18, each with a head 56, a first washer 20, a second washer 32 and a nut 30. However, as shown in FIG. 3, four such bolts 18 attach each leg 12 to the structural top 10 and the respective skid 14.

The profile of the feet 24 both at the top of the leg 12 and the bottom of the leg 12 is such that it fits tightly in the respective pod in which it fits. This provides self-alignment of the leg 12 within the pods 16.

In this embodiment, the side of the leg is generally flat, as shown in FIGS. 15 to 18 so the feet extend laterally relative to that side. In other embodiments, such as that of FIG. 9, no such lateral extension of the foot 24 is present.

In the embodiment of FIG. 8, the entirety of the leg 12 can be made of a plastics or composite material, including the feet 24. As a plastics or composite material, the legs can have a contrasting colour to the structural top and the structural skid, which instead in this embodiment are made of a metal such as aluminium or steel. By virtue of that contrasting colour, the legs can act as a manufacturer or owner identifier, and being plastic or composite, scratches will not scratch off that colour, thus providing longevity to the colouring. This contrasts to paint which would quickly rub off or scratch due to the regular use of a forklift to load and unload the pallets from vehicles, or from handling them within a factory.

In place of the metal washers, coloured plastic washers may be provided, or such metal washers may be supplemented with coloured plastic washers as shown in the following alternative embodiment.

Referring now to FIG. 19, the alternative embodiment is shown in exploded view. As can be seen, the pallet 100 still has a structural top 10, nine legs 12, three structural skids 14, nuts 30, bolts 18 and washers 20. It can also have further washers 30 at the bottom, as in the preceding embodiment. However, they are not shown in this embodiment. The nine legs 12 in this embodiment, however, have been changed to have generally hexagonal column-like forms around all four sides thereof, as an aesthetic change. With this change, the feet 24 no longer extend laterally from the sides of the legs. Instead they are integrated into the profile at the top and bottom of the legs.

Additionally, this alternative embodiment is provided with liners 42. The liners 42 can be positioned between the legs 12 and the structural top 10 and between the legs 12 and the structural liners 14. Although both are optional, as shown they are preferred to be provided at both the top and the bottom of the legs 12.

The liners 42 in this embodiment are formed from a plastics material. As a result, they can contrast in colour to other elements of the pallet, like the legs in the previous embodiment. However, if in this embodiment the legs 12 as well as the structural top and the structural skids are made of metal, the liners 42 may contrast with all of these elements. This is shown in greater detail in FIG. 11, which is an enlarged view of area M shown in FIG. 10. FIG. 10, like FIG. 6, is a section through the pallet 103 with pairs of bolts 18 in each of three of the legs 12.

As shown in FIG. 11, the liners 42 have edge flanges 58 that remain visible after the liners 42 have been sandwiched between the structural top 10 and the leg 12 and between the structural skid 14 and the leg 12. As these edge flanges 58 remain visible, when made of a contrasting colour they can be used to identify the owner of the pallets. As can be seen in FIG. 11, this embodiment also differs from that of FIG. 8 in that the washers 20 provided between the heads 56 of the bolts 18 and the top sheet 34 is much larger. That is because these washers are instead also provided as a plastic or composite component for contrasting relative to the colour of the structural top 10. Although the washers 20 of the previous embodiment can instead be used, these larger washers provide additionally useful means for identifying the owner of the pallets 100.

Referring back to FIG. 9, there are then supplementary washers 60 also provided in this embodiment. These washers can be used to fill the tooling gap between the heads 56 of the bolts 18 and the washers 20. These are also optional. However, they tidy up the upper surface of the pallet 100 which is useful since due to the larger washers 20, the bolts heads will now sit more flush with the uppermost surface of the pallets.

Referring next to FIGS. 12 to 14, the loop 28 of tubular material for the skids 14 is shown. As the skids are significantly narrower than the structural top, the shape of the loop 28 is narrower for the skids 14. The length of the loop, however, can be the same as that for the structural top.

Whereas the flattened sides 44 were tapered in the loop 26 for the structural top 10, in this embodiment, for the structural skids, the flattened sides 44 are instead parallel, as discussed above. They can instead be tapered if preferred. As with the structural top, top and bottom sheets can be affixed to this loop 28. This may again be by welding.

Referring finally to FIGS. 15 to 18, a preferred embodiment for the leg 12 is shown. This is the leg from FIG. 3. As can be seen, and as previously discussed, the leg 12 has a generally flat sidewall 62 and the feet 24 extend laterally thereof. However, the leg 12 is generally hollow and has a skeletal structure formed therein. This skeletal structure comprises a series of longitudinally extending slats 64 that interconnect to form a honeycomb-like lattice. The configuration shown is one of many possibilities for this lattice. The lattice provides vertical loading strength for the legs 12 is that is the predominant force that will be experienced by the legs. As the slats also connect to the sidewalls, however, there is lateral strength as well to resist forces that may be imparted thereto during loading and unloading with a forklift.

As can be seen best in FIG. 18, the upper profile of the legs 12 include shapes 66 (or bumps) configured to fit inside the pods 16. In this embodiment, due to the intermeshing hexagonal arrangement of the pods, there are five such shapes 66 both at the top and the bottom of the legs 12. The four corner ones of these shapes 66 are provided with tubes 68 extending from top to bottom through which the bolts 18 can be inserted during assembly of the pallet 100. The use of such tubes 68 controls the position of the bolts—keeping them, and thus the legs, straight and perpendicular to the top 10, and facilitates the insertion of the bolts 18 through the components when assembling the pallets. However, in other embodiments the bolts 18 may simply fit between slats 64 of the legs 12.

As shown, it is usual for the slats 64 to have a thinner wall section than the sidewalls 62 (and end walls) of the legs 12. Furthermore, to increase the strength of the overhanging feet 24, the feet can have slats or flanges that can be thicker than the rest of the slats 64.

The present invention has been described above purely by way of example. Modifications in detail may be made to the present invention within the scope claims as appended hereto.

1. A pallet with a structural top, the structural top comprising a loop of tubular material around its perimeter, a top sheet and a bottom sheet,
wherein the loop of tubular material is a single length of tubular material and is configured to bend or form around a structure of the structural top to form the perimeter of the structural top, and
wherein the tubular material has an external profile on a top portion and a bottom portion of the loop that provides a flattened region for receiving the top sheet and the bottom sheet of the structural top.

2. The pallet of claim 1, wherein the external height of the loop of tubular material is at least 50% of the height of the structural top of the pallet.

3. The pallet of claim 1, wherein the tubular material has generally round section.

4. (canceled)

5. (canceled)

6. (canceled)

7. The pallet of claim 1, wherein the loop of tubular material is formed from a bent tube of metal.

8. (canceled)

9. The pallet of claim 1, wherein the flattened regions taper relative to one another towards the inside of the loop.

10. The pallet of claim 1, wherein the loop contacts a straight part of walls of pods provided in the structural top.

11. (canceled)

12. The pallet of claim 1, wherein the pallet comprises at least four legs.

13. The pallet of claim 12, wherein the pallet comprises one or more structural skid, and each leg extends between the structural top and one of the one or more structural skid.

14. The pallet of claim 13, wherein the structural top and the skid are joined via one or more of the legs using one or more nut and bolt through one or more hole in the structural top, the structural skid and the one or more of the legs.

15. The pallet of claim 14, wherein washers are used to spread the loading from the nut and a head of the bolt.

16. The pallet of claim 12, wherein the legs are made of a plastics or composite material and the structural top is made of metal.

17. The pallet of claim 12, wherein liners are provided between the legs and the structural top.

18. The pallet of claim 17, wherein the liners are made of a plastics or composite material.

19. (canceled)

20. (canceled)

21. (canceled)

22. (canceled)

23. (canceled)

24. (canceled)

25. The pallet of claim 1, wherein the top sheet and the bottom sheet are each deformed at intervals along their respective lengths and widths to provide pods that protrude inward, relative to outer extremities of the structural top, from a respective outer plane of the respective sheet.

26. The pallet of claim 25, wherein the top and bottom sheets are juxtaposed to each other in mirror-image, or facing, fashion, with their respective pods being inwardly oriented, such that floors of opposing pods engage in contact zones, the opposing pods being joined together at those contact zones.

27. The pallet of claim 26, wherein the opposing pods are joined together by welding them together at their floors in the contact zones.

28. The pallet of claim 27, wherein the pods have openings in their floors.

29. The pallet of claim 25, wherein the pods are round, hexagonal or square.

30. The pallet of claim 25, wherein the pallet comprises at least four legs and the legs are formed with a profiled top or bottom that fits into one or more of the pods so that the pods and the legs self-align within the pods to facilitate assembly of the pallet.

31. The pallet of claim 12, wherein liners are provided between the legs and the structural top and the liners are formed with a profiled top or bottom that fits into one or more of the pods so that the pods and the legs and the liners self-align within the pods to facilitate assembly of the pallet.

32. (canceled)

33. (canceled)

34. (canceled)

35. (canceled)

36. (canceled)

37. (canceled)

38. (canceled)
